(19) United States
(12) Patent Application Publication
(10) Pub. No.: US 2011/0116626 A1
(43) Pub. Date: May 19, 2011

(54) METHOD FOR PROCESSING DATA IN VARIOUS ENCODED DOMAINS

(75) Inventor: Wulf Harder, Geesthacht (DE)

(73) Assignee: SIA WHITECRYPTION, Riga (LV)

(21) Appl. No.: 12/937,745

(22) PCT Filed: Apr. 14, 2009
(86) PCT No.: PCT/EP2009/002727

§ 371 Date: Jan. 28, 2011

(30) Foreign Application Priority Data
Apr. 14, 2008 (DE) 10 2008 019 620.7

(51) Int. Cl. H04L 9/28

(52) U.S. Cl. 380/28

(57) ABSTRACT

A method for processing data in various encoded domains, wherein the encoded domains exchange data by emulating the encodings or decodings, respectively, of other domains.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method for processing data in various encoded domains.

Programs are protected against analysis or manipulation by transformations which also transform the processed data. These transformations are also called obfuscation. The processing of the data is also called computing in an encrypted domain. There are various kinds of transformations, which have advantages and disadvantages with respect to the security of the encoding or to the speed of execution of the transformed program.

Various encoded domains (also called encrypted domains) cannot be used in one processing chain, because the data encodings are incompatible. The concatenation compels a disclosure of the processed data on the interface of the domains.

The present invention is based on the objective to provide methods for processing data in various encoded domains that permit a concatenation of processing steps in various domains.

### BRIEF SUMMARY OF THE INVENTION

Data for a second domain are encoded in a first domain, wherein the first domain emulates the encoding of the second domain.

Data are encoded in a first domain and are decoded in a second domain, wherein the second domain emulates the encoding of the first domain.

Data are encoded in a first domain and decoded in a second domain, wherein the first domain emulates the encoding of a third domain and the second domain emulates the decoding of the third domain.

In summary, the present invention is related to methods for processing data in various encoded domains, wherein the encoded domains exchange data by emulating the encodings or decodings, respectively, of other domains.

### DETAILED DESCRIPTION OF THE FIGURES OF THE DRAWINGS

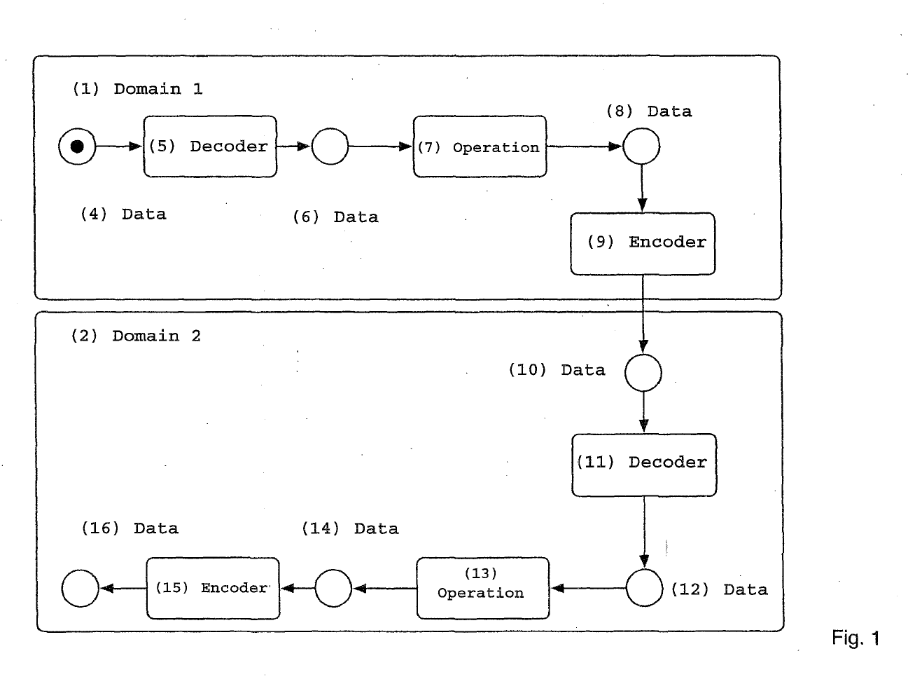

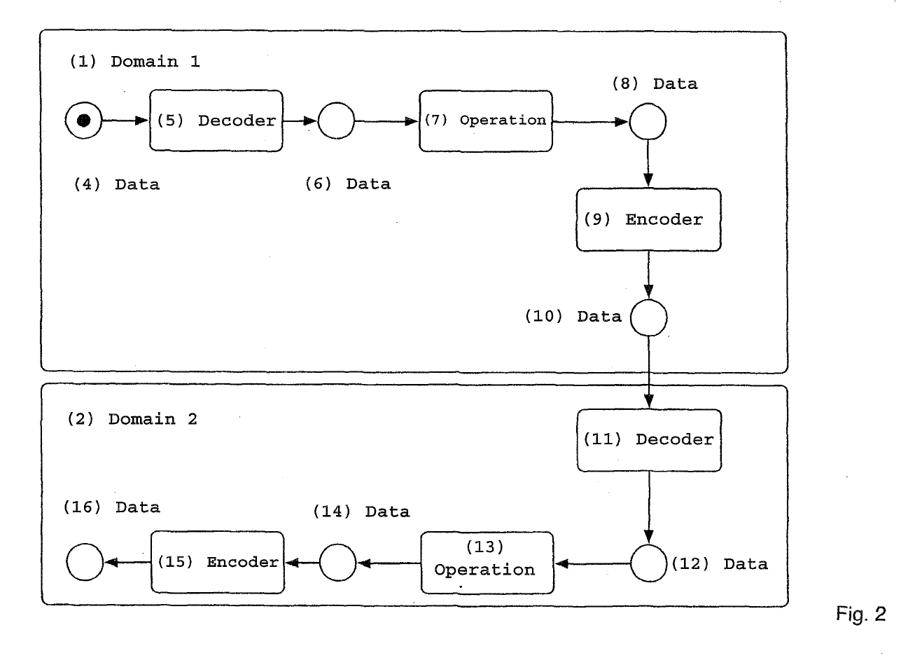

FIG. 1 or 2, respectively, shows a Petri net. In both examples, data (4) encoded in domain (1) are decoded to data (6) by a decoder (5), which are then processed to data (8) by an operation (7). The data (8) are encoded to data (10) by an encoder (9). A decoder (11) decodes the data (10) to data (12), which are then processed to data (14) by an operation (13) and encoded to data (16) by an encoder (15). The data have never left the encoded domains, but they have changed them.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

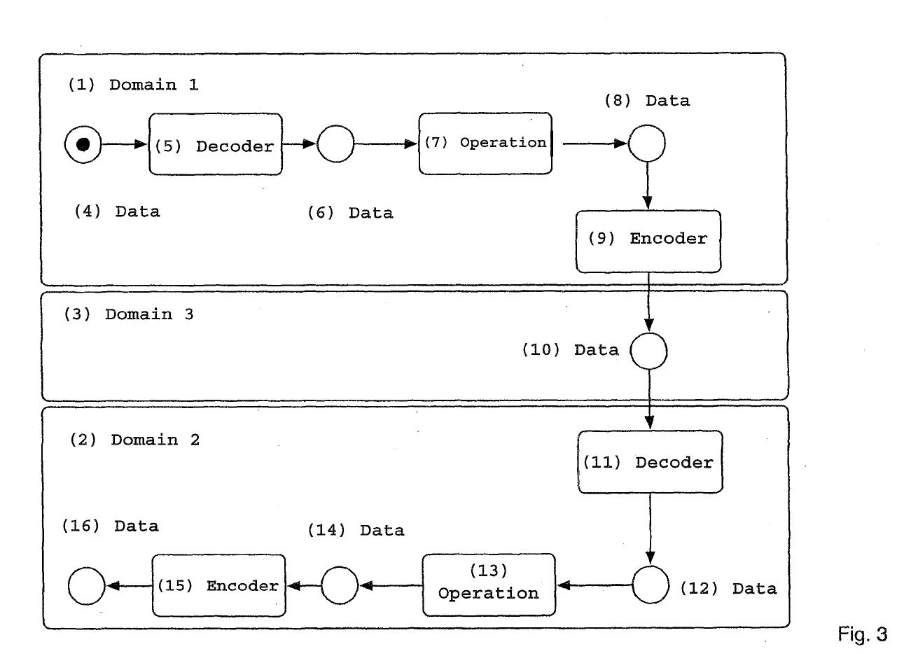

The difference between FIG. 1, FIG. 2 and FIG. 3 consists in the following:

In FIG. 1, the domain (1) emulates the encoding of the domain (2) by using the encoder (9).

In FIG. 2, the domain (2) emulates the decoding of the domain (1) by using the decoder (11).

In FIG. 3, the domain (1) emulates the encoding of the domain (3) by using the encoder (9), and domain (2) emulates the decoding of the domain (3) with the decoder (11).

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for processing data in various encoded domains, characterised in that data for a second domain are encoded in a first domain.

2. A method for processing data in various encoded domains, characterised in that data are encoded in a first domain and are decoded in a second domain.

3. A method for processing data in various encoded domains, characterised in that data for a third domain are encoded in a first domain, and the data of the third domain are decoded in a second domain.
